(19) United States
(12) Patent Application Publication
(10) Pub. No.: US 2005/0135317 A1
(43) Pub. Date: Jun. 23, 2005

(54) Method and system for multicast scheduling in a WLAN

(76) Inventors: Christopher Ware, Abbotsford (AU); Randy L. Ekl, Lake Zurich, IL (US); Thierry Rakotoarivelo, Waverley (AU)

Correspondence Address: MOTOROLA INC, 600 NORTH US HIGHWAY 45, ROOM AS437, LIBERTYVILLE, IL, 60048-5343, US

(21) Appl. No.: 10/743,298

(22) Filed: Dec. 22, 2003

(51) Int. Cl. H04Q 7/24

(52) U.S. Cl. 370/338

(57) ABSTRACT

A method and system for scheduling multicast transmissions in a WLAN involves transmissions between a Quality of Service (QoS) Access Point (QAP) (105) and a plurality of stations (110). The method includes transmitting a first group poll (410) from a QAP (105) to each station (110) in a multicast group comprising a plurality of stations (110) (step 705). An active station (110) and inactive stations (110) among said plurality of stations (110) are then identified (step 510). Next, a directed Contention Free (CF) poll (425) is transmitted from the QAP (105) to the active station (110) (step 715). An inbound QoS data frame (415) is then transmitted from the active station (110) to the QAP (105) (step 720). An outbound QoS data frame (420) corresponding to the inbound QoS data frame (415) is then multicast from the QAP (105) to the inactive stations (110) (step 725).

### FIELD OF THE INVENTION

The invention relates generally to a method and system for scheduling multicast transmissions of Internet Protocol (IP) data packets in a Wireless Local Area Network (WLAN). The invention is particularly useful for, but not necessarily limited to, reducing delay and jitter in multicast transmissions.

### BACKGROUND ART OF THE INVENTION

Wireless Local Area Network (WLAN) protocols such as those based on the IEEE 802.11 standards are designed to recreate the high Quality of Service (QoS) that is typically supplied in wired networks that use standard LAN protocols such as Ethernet. High QoS includes uninterrupted network connections, high throughput and reliable delivery of data. However maintaining such high QoS in a WLAN is more difficult than in a wired network. Wireless connections exhibit negative characteristics such as “fast fading,” “shadow fading” and long-time-scale variations that are not found in wired networks. “Fast fading” concerns rapid fluctuations in signal integrity on the order of milliseconds due to various types of interference; “shadow fading” concerns relatively slower fluctuations on the order of hundreds of milliseconds; and long-time-scale variations concern even slower fluctuations in signal integrity often due to movement of a user terminal such as a smart phone or Personal Digital Assistant (PDA). Maintaining a high QoS in a WLAN therefore requires vigilant attention to error detection and correction and also requires careful monitoring of the conditions of the wireless link.

Despite the above negative characteristics, WLANs are frequently preferred over wired LANs, primarily because the user terminals of a WLAN are portable but also for numerous other reasons. For example, with WLANs it is easy to use “ad hoc” networks that can be quickly assembled and torn down, and WLANs may also be more economical when compared with the high cost of infrastructure wiring.

The IEEE 802.11 standards concern the operation of a network's Media Access Control (MAC) layer. The MAC layer resides just above a network's Physical (PHY) layer and is responsible for controlling access to the wireless channel. The MAC receives MAC Service Data Units (MSDUs) from the higher layers. MSDU's may be fragmented into smaller MAC Protocol Data Units (MPDUs), which are then transported between network stations across the wireless medium. Network stations are devices connected to the network that may be mobile, portable, or stationary. MPDUs are transmitted between network stations using a carrier sense multiple access with collision avoidance (CSMA/CA) protocol. Collision detection such as that used in the Ethernet protocol cannot be used in wireless transmissions, because when a wireless station is transmitting it cannot hear other stations on the network as its own signal will interfere with any received signal. The IEEE 802.11 standards refer to the above method of channel access as the Distributed Coordination Function (DCF).

The 802.11 standards also describe a second channel access method for networks where an Access Point (AP) is present. This method, referred to as the Point Coordination Function (PCF), uses polling to provide access to the wireless medium. The AP constructs a polling list that determines the order in which the stations within the network will be polled.

In an IEEE 802.11 network, stations are collected into a Basic Service Set (BSS). A BSS may comprise an ad hoc network where all stations in the network can communicate directly with all other stations. Alternatively a BSS may include an AP in which case it is called an infrastructure BSS. In an infrastructure BSS, all stations communicate exclusively through the AP. The AP is often connected to a wired LAN and therefore can significantly increase the range and resources available to a BSS.

Extensions to the existing IEEE 802.11 protocol will include the IEEE 802.11(e) QoS extensions. These are based on both the CSMA/CA channel access method, and on the polling method. In an infrastructure BSS that is providing QoS, a QoS AP (QAP) must schedule all data downlinks to all stations in the BSS and all data uplinks from the stations to the QAP. To avoid delay and jitter, all uplinks and downlinks must be scheduled efficiently. Optimizing such scheduling using a scheduling algorithm is often a complex process that requires consideration of numerous variables such as the specific QoS requirements of individual stations, fading disruptions, processing time, variable queuing time, and the load of individual stations (i.e., the amount of data queued at a station waiting to be uplinked to the QAP).

Additional variables need to be considered when scheduling multicast data traffic. In a multicast environment only one member of a many-to-many multicast group is able to operate as a data traffic source at any given time. Often such multicast groups involve half duplex group voice communications requiring “push-to-talk-release-to-listen” switches. For example, emergency response teams such as police and firefighters may use half duplex voice over IP (VoIP) communications equipment to multicast a dispatch call to all team members and then to receive a response from a single team member. These multicast communications work on top of Transmission Control Protocol/Internet Protocol (TCP/IP) based networks, and use multicast routers to transmit IP packets to multiple destinations.

In a half duplex group voice communication network, at any given time only one member of the group can be an active transmitter. Further, the active group member who has the authority to transmit must often change rapidly from one member to another. Identifying the active group member who has the authority to transmit, as part of a multicast scheduling process, is generally done by polling. But polling all group members to determine an active member is highly inefficient and is also limited in terms of scalability to large multicast groups.

### SUMMARY OF THE INVENTION

According to one aspect, the present invention is therefore a method for scheduling multicast transmissions in a WLAN. The method includes the steps of: transmitting a first group poll from a Quality of Service (QoS) Access Point (QAP) to each station in a multicast group comprising a plurality of stations; identifying an active station and inactive stations among the plurality of stations; transmitting a directed Contention Free (CF) poll from the QAP to the active station; transmitting an inbound QoS data frame from the active station to the QAP; and multicasting an outbound QoS data frame corresponding to the inbound QoS data frame from the QAP to the inactive stations.

According to another aspect, the invention is a system of a WLAN used for scheduling multicast transmissions, the system including: a QAP having a back-haul interface, an inbound interface and an outbound interface; and a plurality of stations operatively connected to the QAP through one of the back-haul, inbound, or outbound interfaces; the QAP operative to receive a single poll for a multicast group consisting of some of the stations in the plurality of stations, and to transmit through the outbound interface or through the back-haul interface a group poll to the multicast group to identify an active station among the plurality of stations.

### BRIEF DESCRIPTION OF THE DRAWINGS

In order that the invention may be readily understood and put into practical effect, reference will now be made to a preferred embodiment as illustrated with reference to the accompanying drawings, wherein like reference numbers refer to like elements, in which:

FIG. 1 is a schematic diagram illustrating a WLAN involving multicast traffic streams between a QAP and various stations;

FIG. 2 is a schematic diagram illustrating a WLAN and various types of data traffic such as multicast voice traffic, unicast voice traffic, and video traffic that may need to be managed by a QAP;

FIG. 3 is a schematic diagram illustrating a WLAN showing that all sending and receiving QSTAs may form a single multicast group having a single IP address;

FIG. 4 is a series of timing diagrams illustrating how a MAC scheduler at a QAP schedules, according to an embodiment of the present invention, a multicast group as a single entity;

FIG. 5 is a flow diagram illustrating a process for identifying an active QSTA according to an embodiment of the present invention;

FIG. 6 is a state diagram illustrating a multicast scheduling process performed by a system of a WLAN according to an embodiment of the present invention; and

FIG. 7 is a flow diagram illustrating a method for scheduling multicast transmissions in a WLAN according to an embodiment of the present invention.

### DETAILED DESCRIPTION OF THE PREFERRED EMBODIMENT OF THE INVENTION

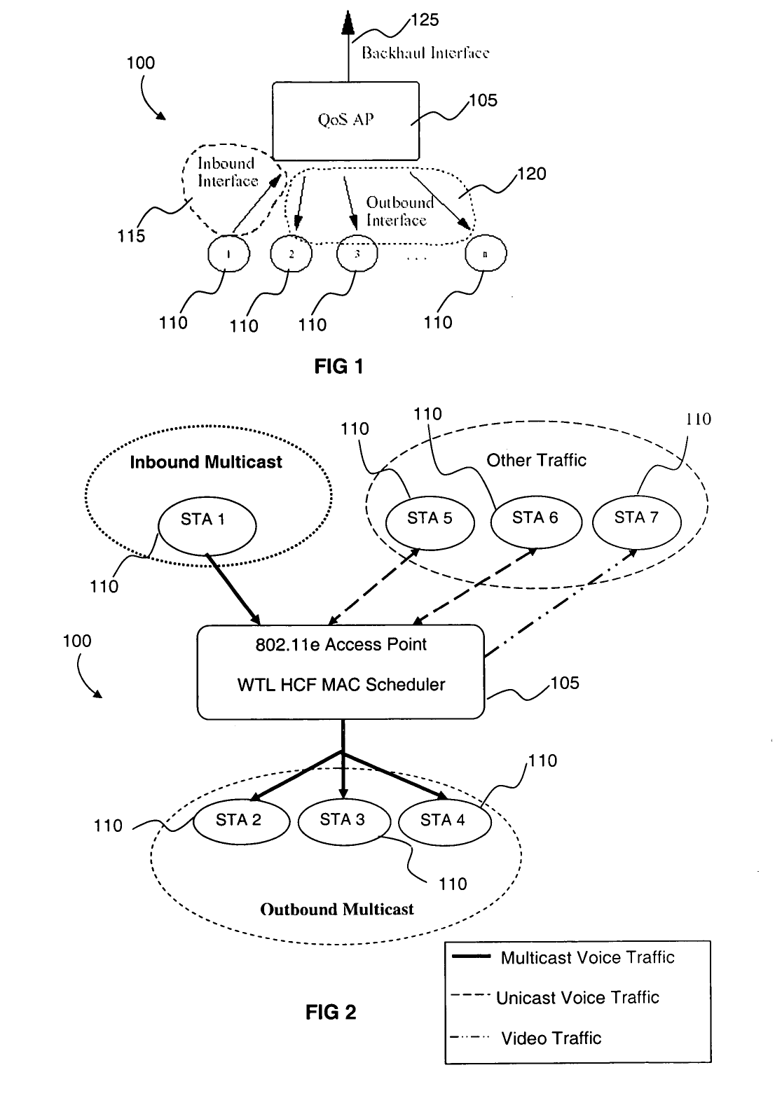

Referring to FIG. 1, there is a schematic diagram illustrating a WLAN 100 involving multicast traffic streams between a QAP 105 and various QoS STAs (QSTAs) 110. In the WLAN 100 multicast traffic is classified as either inbound or outbound. In a typical group voice application, the role of the QAP 105 is to relay inbound or outbound multicast voice traffic and forward the traffic over a backbone or air interface according to an Open Systems Interconnection (OSI) level 2 spanning tree (OSI levels are well known in the art and therefore are not described in further detail). For example, each QSTA 110 could correspond to a member of an emergency response team and a dispatch call could be multicast from the QAP 105 to each team member. An inbound multicast interface 115 is defined as an interface that handles multicast traffic that originates from a QSTA 110 and is sent to the QAP 105. An outbound multicast interface 120 is defined as an interface that handles multicast traffic that is sent from the QAP 105 toward a QSTA 110. IP packets sent across an outbound multicast interface 120 may have originated internally within the WLAN 100, or may have originated externally and were delivered to the QAP 105 across a backhaul interface 125.

In a group voice application such as a WLAN 100 for an emergency response team as described above, each QSTA 110 (corresponding to a team member in this case) sends a unicast message to a call processing unit (not shown in the figures) to indicate that the QSTA 110 is part of a specific multicast group, and that the multcast group is managed by a specific QAP 105. Such unicast messages are generally out of band, meaning that they are not part of the same transmission sessions used for the multicast group voice transmissions. The call processing unit handles group admission control, resource management, security policies, address assignments, etc., at the system level as well as at the air interface level.

Referring to FIG. 2, there is a schematic diagram illustrating a WLAN 100 and various types of data traffic such as multicast voice traffic, unicast voice traffic, and video traffic that may need to be managed by the QAP 105. Assuming that a general OSI level 3 multicast protocol has been implemented, each QSTA 110 participating in a multicast group must register with appropriate routers in a multicast path. OSI level 2 also operates with a reserved address sub-space for multicast traffic. A mapping exists between each OSI level 3 and OSI level 2 multicast addresses, which thus defines a mapping between OSI level 3 and OSI level 2 multicast groups. Based on this information, inbound multicast packets are forwarded by an OSI level 2 forwarding engine to the relevant outbound multicast interface 120.

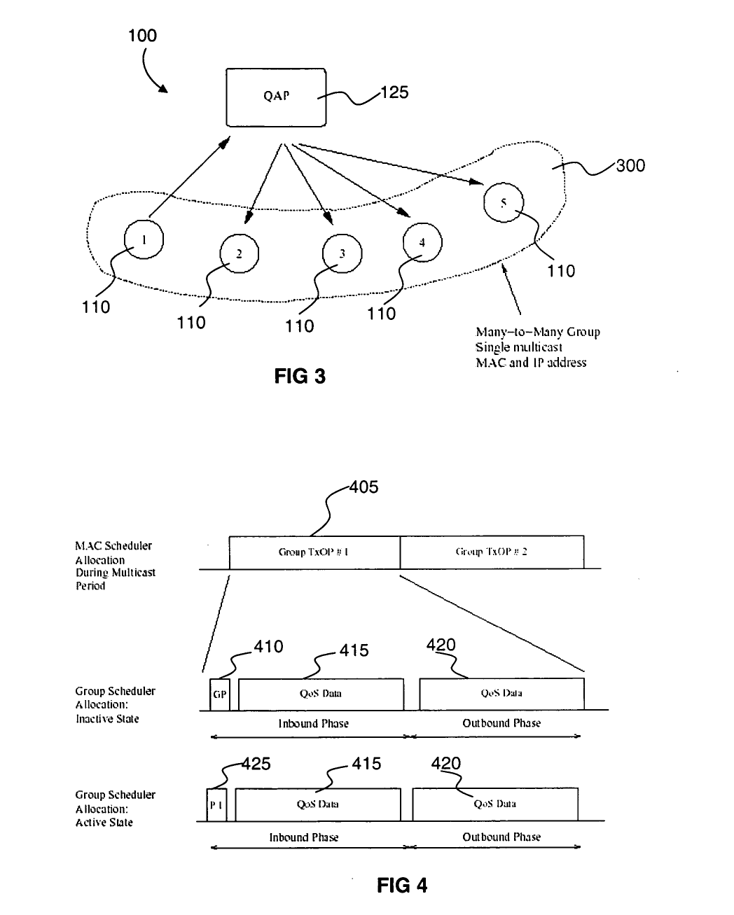

Referring to FIG. 3, there is a schematic diagram illustrating a WLAN 100 and showing that all sending and receiving QSTAs 110 may form a single multicast group 300 having a single IP address. Therefore, according to the present invention, where either an inbound or an outbound multicast is to be supported without local replication, multicast traffic can be treated in the same manner as unicast traffic. That applies to any traffic that is a) forwarded from the back-haul interface 125 toward the outbound interface 120, or b) forwarded from the inbound interface 115 across only the back-haul interface 125. In these situations, various techniques can be used to ensure that priority for multicast voice traffic is maintained regardless of the total traffic load on the WLAN 100. Such techniques include for example always transmitting multicast traffic, when present, ahead of any queued unicast traffic.

Another more likely scenario is where local replication and forwarding on the outbound multicast interface 120 is required for data packets received on the inbound multicast interface 115. Here, any significant delay in replicating and transmitting the data packets may cause delay and jitter at all QSTAs 110 in a multicast group. Therefore an efficient method is required to handle such uplink transmissions sent to a multicast group.

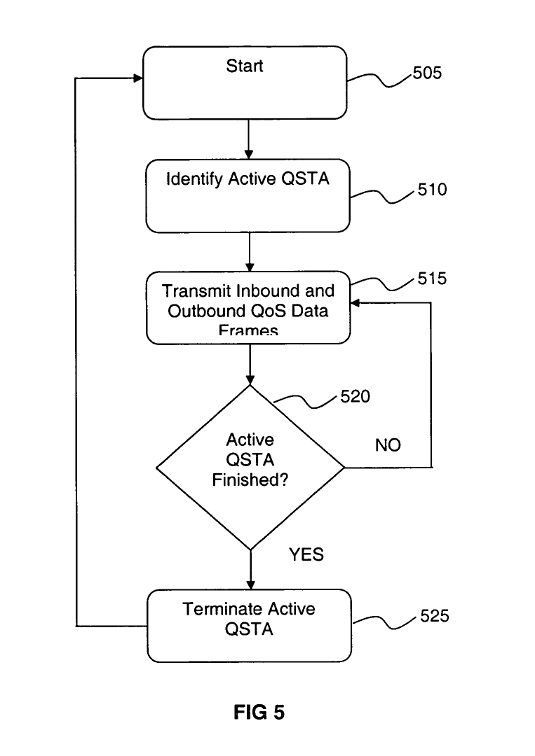

Referring to FIG. 4, there is a series of timing diagrams illustrating how a MAC scheduler at the QAP 105 schedules, according to an embodiment of the present invention, a multicast group as a single entity, rather than individually scheduling any of the QSTAs 110 in the group. A simple batching method is used in which an inbound transmission opportunity (TxOP) is allocated to the multicast group, followed immediately by an outbound TxOP. Thus a first group transmission opportunity (TxOP) 405 may include a group poll 410, an inbound phase QoS data frame 415, and an outbound phase QoS data frame 420.

A lower level scheduling function, termed a group scheduler, is used to determine an active QSTA 110 within a multicast group and then execute the group TxOP 405. Commencing in a state where no QSTA 110 has been identified as an active member, all multicast group members are first polled with a group poll 410 until an active QSTA 110 is identified. A group poll is a contention free (CF) poll sent to the group multicast address. The active station is defined as the QSTA 110 that responds to the group poll 410 with a queued inbound QoS data frame 415. Non-active QSTAs 110 do not respond to the group poll 410. Note that such a procedure is in contrast to a typical CF poll, where a QSTA 110 with no data to send would respond with a QoS null frame.

Once an active QSTA 110 is identified, group polling is stopped. The active QSTA 110 then remains the active QSTA 110 until it responds to a directed CF poll 425 with a QoS null frame. At that point group polling recommences and the process is repeated. Referring to FIG. 5, there is a flow diagram illustrating the above-described process for identifying an active QSTA 110. The process begins at a start step 505. At step 510 an active QSTA 110 is identified using a group poll 410. At step 515, after an active QSTA 110 is identified, it proceeds to transmit inbound QoS data frames 415 across the inbound interface 115, and the QAP 105 multicasts corresponding outbound QoS data frames 420 across the outbound interface 120. Next, at step 520, the group scheduler determines whether the active QSTA 10 is finished transmitting by sending a directed CF poll 425 to the active QSTA 110. If the active QSTA 110 is not finished transmitting, the process returns to step 515 where the active QSTA 110 responds to the directed CF poll 425 with additional inbound QoS data frames 415. If at step 520 the active QSTA 110 is finished transmitting, it responds to the directed CF poll 425 with a QoS null frame. The process then continues to step 525 where the active QSTA 110 is terminated. The process is then repeated by returning to the start step 505.

It is possible that a collision will occur at step 510 if two QSTAs 110 both attempt to become an active QSTA 110 at the same time. For example two QSTAs 110 may both respond to a group poll 410 with a queued inbound QoS data frame 415. In that case the QAP 105 may execute a back-off algorithm. Such back-off algorithms are well known in the art. For example, a back-off algorithm may require a QSTA 110 to generate a random number between zero and a contention window. The random number determines an amount of time that the QSTA 110 must wait before transmitting. When a back-off counter in the QSTA 110 reaches zero, the QSTA 110 can again transmit an inbound QoS data frame 415 to attempt to become the active QSTA 110.

An appropriate transmission rate for multicast outbound QoS data frames 420 must be selected to suit all members of the multicast group. Unless a system employing increased power is used, as discussed in more detail below, the minimum rate must be selected. However, Transmit Power Control (TPC) algorithms, such as those known in the art, can be employed to transmit at a rate higher than the transmit rate of the lowest member of the multicast group. Such algorithms depend on the range of transmit rates among multicast group members, individual link stability within group members, and battery power constraints.

Data frames arriving on the back-haul interface 125 may be queued and treated as a single QSTA 110 within the multicast group. The back-haul interface 125 may therefore sometimes be considered as the active QSTA 110. In such a situation the group scheduler does not need to poll and an inbound TxOP does not need to be executed. Alternatively, group polling may be undertaken, and an internal response to a group poll 410 may be generated by the back-haul interface 125.

The present invention therefore ensures that data can be forwarded to all multicast group members with very high priority, thereby minimizing additional delay and jitter. Further, techniques such as adaptive uplink polling as described in U.S. patent application Ser. No. 10/631,123 (herein incorporated by reference) may be employed on the multicast group as a single entity. Such techniques ensure that the half duplex nature of a group voice application is scheduled efficiently, minimizing the impact on other traffic types in a WLAN network 100.

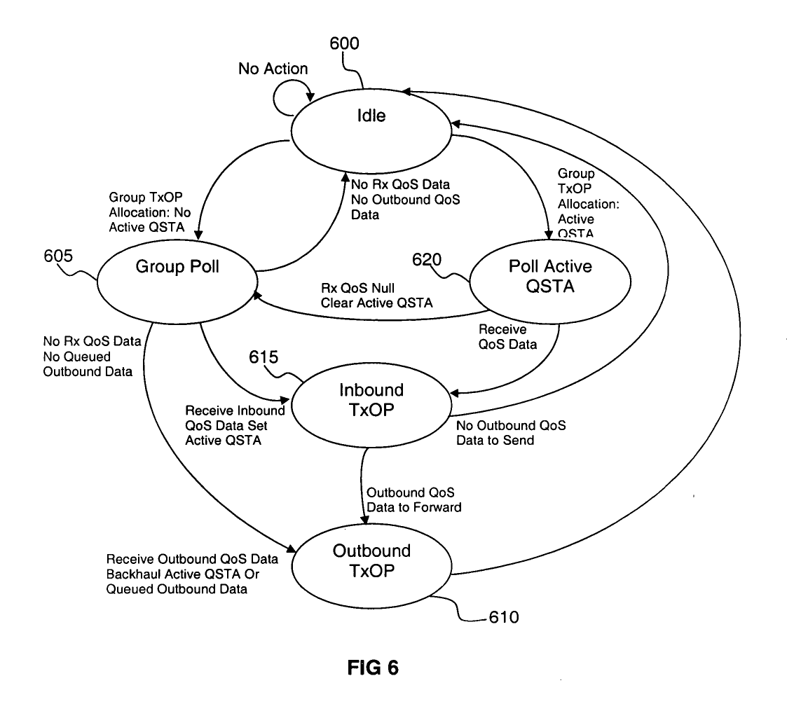

Referring to FIG. 6, there is a state diagram illustrating a multicast scheduling process performed by a system of a WLAN 100 according to an embodiment of the present invention. At state 600 the system is idle. Assuming that no active QSTA 110 has been identified, the system then changes to state 605 by issuing a group poll 410 from the QAP 125. If an inbound QoS data frame 415 is not received in response to the group poll 410, and no outbound QoS data is queued for transmission, the system returns to state 600. If however there is outbound QoS data queued for transmission, or if QoS data has been received at the back-haul interface 125, then the system changes to state 610 where an outbound TxOP is executed. After the outbound TxOP is executed, the system returns to idle state 600.

If however at state 605 an inbound QoS data frame 415 is received in response to the group poll 410, the system proceeds to state 615 where an inbound TxOP is executed. If there is then an outbound QoS data frame 420 to be transmitted, the system changes to state 610 where an outbound TxOP is executed. The system returns to idle state 600 if at state 615 there is no outbound QoS data frame 420 to be transmitted. If at state 600 a QSTA 110 is known to be an active QSTA 110, the system changes to state 620 where a directed CF poll 425 is sent from the QAP 125 to the active QSTA 110. The system then returns to state 615 if an inbound QoS data frame 415 is received in response to the directed CF poll 425. Otherwise, if a QoS null frame is received in response to the directed CF poll 425, the active QSTA 110 is cleared and the system returns to state 605 where another group poll 410 is transmitted from the QAP 125.

Although multicast frames are not acknowledged according to the present invention, transmission reliability can be improved through various other means. First, for example, transmission power for both inbound and outbound frames can be increased. Second, the transmit rate can be reduced to one step lower than the lowest rate of the multicast group members. That is a very simple alternative that can significantly increase system reliability; however, a penalty is that there is reduced channel efficiency and system capacity. Third, outbound QoS data frames 420 can be statistically repeated, thereby introducing redundancy. That approach introduces statistical repetition of both inbound and outbound multicast frames based on channel characteristics obtained through a Link Adaptation algorithm. For example, if the range of preferred transmit rates among a multicast group were relatively small (e.g., within one or two rates) a very low rate of repetition may be employed. As the spread of transmit rates increases, the rate of repetition is also increased.

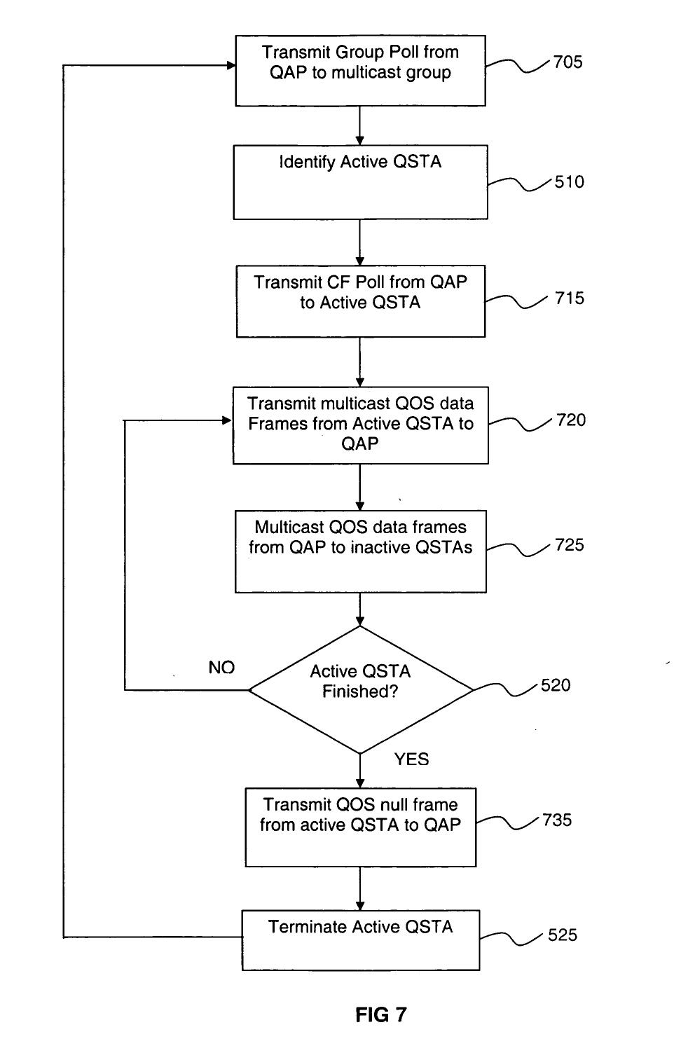

Referring to FIG. 7 there is a flow diagram illustrating a method 700 for scheduling multicast transmissions in a WLAN 100 according to an embodiment of the present invention. The method 700 begins at step 705 where a first group poll 410 is transmitted from a QAP 105 to each QSTA 110 in a multicast group. Next, at step 510, an active QSTA 110 is identified. An active QSTA 110 is preferably a QSTA 110 that transmits, in response to the group poll 410, a inbound QoS data frame 415 to the QAP 105. QSTAs 110 that do not transmit an inbound QoS data frame 415 in response to the group poll 410 are thus identified as inactive QSTAs 110.

The method 700 then continues at step 715 where the QAP 105 transmits a directed CF poll 425 from the QAP 105 to the active QSTA 110. Next at step 720 the active QSTA 110 transmits one or more multicast inbound QoS data frames 415 to the QAP 105. At step 725, the QAP 105 then multicasts one or more outbound QoS data frames 420, corresponding to the inbound QoS data frames 415 received at step 720, to the inactive QSTAs 110. At step 520 it is determined whether the active QSTA 110 is finished transmitting data. If the active QSTA 110 is not finished transmitting, the method 700 returns to step 720 where additional multcast QoS data frames 415 may be transmitted from the active QSTA 110 to the QAP 105. If however at step 520 the active QSTA 110 is finished transmitting, then the method 700 continues to step 735 where the active QSTA 110 transmits a QoS null frame to the QAP 105. At step 525 the QAP 105 then terminates the active QSTA 110 and the method 700 returns to step 705 where a subsequent group poll 410 is transmitted from the QAP 105 to the multicast group.

The present invention is therefore a method and system for scheduling multicast transmissions of IP data packets in a WLAN 100 that offers several significant advantages over prior art multicast frame exchange methods, including improved channel efficiency, better QoS performance, and reduced power consumption. The invention further enables data to be forwarded to all multicast group members with very high priority, thereby minimizing delay and jitter.

In this specification, including the claims, the terms “comprises,” “comprising” or similar terms are intended to mean a non-exclusive inclusion, such that a method or apparatus that comprises a list of elements does not include those elements solely, but may well include other elements not listed.

The above detailed description provides a preferred exemplary embodiment only, and is not intended to limit the scope, applicability, or configuration of the present invention. Rather, the detailed description of the preferred exemplary embodiment provides those skilled in the art with an enabling description for implementing the preferred exemplary embodiment of the invention. It should be understood that various changes can be made in the function and arrangement of elements and steps without departing from the spirit and scope of the invention as set forth in the appended claims.

1. A method for scheduling multicast transmissions in a WLAN, said method comprising the steps of:
transmitting a first group poll from a Quality of Service (QoS) Access Point (QAP) to each station in a multicast group comprising a plurality of stations;
identifying an active station and inactive stations among said plurality of stations;
transmitting a directed Contention Free (CF) poll from said QAP to said active station;
transmitting an inbound QoS data frame from said active station to said QAP; and
multicasting an outbound QoS data frame corresponding to said inbound QoS data frame from said QAP to said inactive stations.

2. The method of claim 1, wherein the step of identifying an active station among said plurality of stations identifies as said active station a station that transmits, in response to said group poll, an inbound QoS data frame to said QAP.

3. The method of claim 1, further comprising the steps of:
transmitting a QoS null frame from said active station to said QAP; and
transmitting a subsequent group poll from said QAP to each station in said plurality of stations.

4. The method of claim 1, wherein said active station is a back-haul interface.

5. The method of claim 1, wherein said step of identifying an active station comprises executing a back-off algorithm when a collision occurs when two of said stations respond to said first group poll with inbound QoS data frames.

6. The method of claim 1, wherein said inactive stations do not respond to said first group poll.

7. The method of claim 1, wherein said data frames comprise half duplex voice data frames.

8. A system of a WLAN used for scheduling multicast transmissions, the system comprising:
a QAP having a back-haul interface, an inbound interface and an outbound interface; and
a plurality of stations operatively connected to said QAP through one of said back-haul, inbound, or outbound interfaces;
said QAP operative to receive a single poll for a multicast group consisting of some of said stations in said plurality of stations, and to transmit through said outbound interface or through said back-haul interface a group poll to said multicast group to identify an active station among said plurality of stations.

9. The system of claim 8, wherein said QAP comprises a group scheduler.

10. The system of claim 8, wherein said multicast transmissions comprise half duplex group voice transmissions.
